(19) United States
(12) Patent Application Publication
(10) Pub. No.: US 2021/0382437 A1
(43) Pub. Date: Dec. 9, 2021

(54) METHOD FOR GENERATING HOLOGRAM BASED ON SEPARATING AXIS AND APPARATUS FOR THE SAME

(71) Applicant: Electronics and Telecommunications Research Institute, Daejeon (KR)

(72) Inventor: Hyun Eui KIM, Daejeon (KR)

(73) Assignee: Electronics and Telecommunications Research Institute, Daejeon (KR)

(21) Appl. No.: 17/337,959

(22) Filed: Jun. 3, 2021

(30) Foreign Application Priority Data
Jun. 5, 2020 (KR) 10-2020-0068650

(51) Int. Cl. G03H 1/26; G06T 5/50; G06T 5/10; G06K 9/58; G06K 9/46

(52) U.S. Cl. CPC G03H 1/268; G06T 5/50; G06T 5/10; G06T 2207/20221; G06K 9/46; G03H 2001/264; G06K 9/58

(57) ABSTRACT

Disclosed herein is an apparatus for generating a hologram. The apparatus for generating a hologram according to an embodiment of the present disclosure may include: a first pattern generator configured to generate a first hologram pattern that is constructed by modeling a first lens capable of collecting incident light onto a first axis: a second pattern generator configured to generate a second hologram pattern that is constructed by modeling a second lens capable of collecting the incident light onto a second axis; and a hologram pattern combination unit configured to construct a final hologram pattern by combining the first and second patterns.

### CROSS REFERENCE TO RELATED APPLICATION

The present application claims priority to K.R application 10-2020-0068650, filed Jun. 5, 2020, the entire contents of which are incorporated herein for all purposes by this reference.

### BACKGROUND OF THE INVENTION

### Field of the Invention

The present disclosure relates to a method and apparatus for displaying a holographic image and, more particularly, to a method and apparatus for generating a hologram based on a point cloud.

### Description of the Related Art

Hologram technology is a 3D space representation technology that accurately reproduces real 3D objects by recording not only light intensity but also phase information of light as wave.

As a method of generating a hologram, a 3D object is considered as a set of spatial points, and a hologram is generated based on a point cloud representing each of the points constituting the 3D object. When a hologram is generated based on a point cloud, as phase information of light for each point should be recorded, a large amount of calculation for generating a hologram pattern is required.

### SUMMARY

According to a method for generating a hologram based on a point cloud, each object point (e.g., point) is defined by each spherical wave and constitutes an optical field of a hologram plane at a position a distance (z) away from any object point P1.

An optical field for all the point clouds is expressed with as many overlaps as the number of points constituting a hologram. When it is assumed that the resolution of an optical field is Nx*Ny and a total number of points is N0, the total number of calculations required is Nx*Ny*N0. Accordingly, a required amount of calculation and calculation time increase in proportion to the resolution of an optical field and the number of object points. As a memory issue also occurs to a computing device when the resolution of a plane to be calculated increase, methods for efficiently calculating and generating a hologram are being considered.

A technical object of the present disclosure is to provide a method and apparatus for quickly and efficiently generating a hologram image.

Another technical object of the present disclosure is to provide a method and apparatus for quickly generating a hologram image while reducing an amount of computation required for generating the hologram image.

The technical objects of the present disclosure are not limited to the above-mentioned technical objects, and other technical objects that are not mentioned will be clearly understood by those skilled in the art through the following descriptions.

According to one aspect of the present disclosure, a hologram generation device may be provided. The device may include a first pattern generator configured to generate a first hologram pattern, which is constructed by modeling a first lens capable of collecting incident light on a first axis, a second pattern generator configured to generate a second hologram pattern, which is constructed by modeling a second lens capable of collecting the incident light on a second axis, and a hologram pattern combination unit configured to construct a final hologram pattern by combining the first and second patterns.

According to another aspect of the present disclosure, a method for generating a hologram may be provided. The method may include generating a first hologram pattern that is constructed by modeling a first lens capable of collecting incident light on a first axis, generating a second hologram pattern that is constructed by modeling a second lens capable of collecting the incident light on a second axis, and constructing a final hologram pattern by combining the first and second hologram patterns.

The features briefly summarized above with respect to the present disclosure are merely exemplary aspects of the detailed description below of the present disclosure, and do not limit the scope of the present disclosure.

According to the present disclosure, in comparison with an existing method of calculating an optical path length for an overall hologram plane, an amount of calculation may be significantly reduced, and an optical field may be calculated at high speed.

Also, according to the present disclosure, as independent computation may be performed for a first pattern and a second pattern that are configured based on different axial directions, an asymmetrical optical model may be easily constructed.

Also, according to the present disclosure, a storage medium or a storage space required to produce an ultra-high resolution optical field may be flexibly operated, and the resolution of a hologram may be increased due to a shortage of a storage medium or storage space.

Effects obtained in the present disclosure are not limited to the above-mentioned effect, and other effects not mentioned above may be clearly understood by those skilled in the art from the following description.

### BRIEF DESCRIPTION OF THE DRAWINGS

FIG. 1 is a block diagram showing a configuration of a hologram generation device according to an embodiment of the present disclosure.

FIG. 2 is a view illustrating a relationship among a hologram image, a hologram plane and a hologram pattern that are used in a hologram generation device according to an embodiment of the present disclosure.

FIG. 3 is a conceptual diagram illustrating an operation of implementing a target point of a hologram image by a hologram pattern in a hologram generation device according to an embodiment of the present disclosure.

FIG. 4A to FIG. 4C are conceptual diagrams illustrating an operation of implementing a target point of a hologram image by a first hologram pattern, a second hologram pattern, and a final hologram pattern in a hologram generation device according to an embodiment of the present disclosure.

FIG. 5A and FIG. 5B are views illustrating structures of a first hologram pattern and a second hologram pattern that are generated by a hologram generation device according to an embodiment of the present disclosure.

FIG. 6 is a block diagram showing a configuration of a hologram generation device according to another embodiment of the present disclosure.

FIG. 7 is a flowchart illustrating an order in a method for generating a hologram according to an embodiment of the present disclosure.

FIG. 8 is a flowchart illustrating an order in a method for generating a hologram according to another embodiment of the present disclosure.

FIG. 9 is a block diagram illustrating a computing system implementing an apparatus and method for generating a hologram according to an embodiment of the present disclosure.

### DETAILED DESCRIPTION

Hereinbelow, exemplary embodiments of the present disclosure will be described in detail with reference to the accompanying drawings such that the present disclosure can be easily embodied by one of ordinary skill in the art to which this invention belongs. However, the present disclosure may be variously embodied, without being limited to the exemplary embodiments.

In the description of the present disclosure, the detailed descriptions of known constitutions or functions thereof may be omitted if they make the gist of the present disclosure unclear. Also, portions that are not related to the present disclosure are omitted in the drawings, and like reference numerals designate like elements.

In the present disclosure, when an element is referred to as being “coupled to”, “combined with”, or “connected to” another element, it may be connected directly to, combined directly with, or coupled directly to another element or be connected to, combined directly with, or coupled to another element, having the other element intervening therebetween. Also, it should be understood that when a component “includes” or “has” an element, unless there is another opposite description thereto, the component does not exclude another element but may further include the other element.

In the present disclosure, the terms “first”, “second”, etc. are only used to distinguish one element, from another element. Unless specifically stated otherwise, the terms “first”, “second”, etc. do not denote an order or importance. Therefore, a first element of an embodiment could be termed a second element of another embodiment without departing from the scope of the present disclosure. Similarly, a second element of an embodiment could also be termed a first element of another embodiment.

In the present disclosure, components that are distinguished from each other to clearly describe each feature do not necessarily denote that the components are separated. That is, a plurality of components may be integrated into one hardware or software unit, or one component may be distributed into a plurality of hardware or software units. Accordingly, even if not mentioned, the integrated or distributed embodiments are included in the scope of the present disclosure.

In the present disclosure, components described in various embodiments do not denote essential components, and some of the components may be optional. Accordingly, an embodiment that includes a subset of components described in another embodiment is included in the scope of the present disclosure. Also, an embodiment that includes the components described in the various embodiments and additional other components are included in the scope of the present disclosure.

A hologram generation device according to an embodiment of the present disclosure is configured to perform calculation by separating a plane orthogonal to an optical axis into independent 1D structures horizontally (on x-axis) and vertically (on y-axis), that is, in each axial direction, in order to calculate an optical field on an orthogonal 2D plane at a position an arbitrary distance away from an arbitrary voxel, when expressing a spatial position of a voxel to be calculated based on an optical field to be calculated into a spatial coordinate value in an orthogonal coordinates system. When separating an optical field in each axial direction (e.g., horizontally or vertically), a same optical distribution is repeatedly calculated for a direction orthogonal to each axial direction. Accordingly, a hologram generation device is configured to calculate only a value of a single row (or column) for a direction corresponding not to an overall plane of optical field but to each axial direction and then to duplicate the value of the single row (or column), which is already calculated, for a value for an orthogonal direction. Thus, the hologram generation device may significantly reduce an amount of computation required to construct an optical field since it calculates only a value of a single row (or column) for a direction corresponding to each axial direction.

Hereinafter, embodiments of the present disclosure will be described with reference to the accompanying drawings.

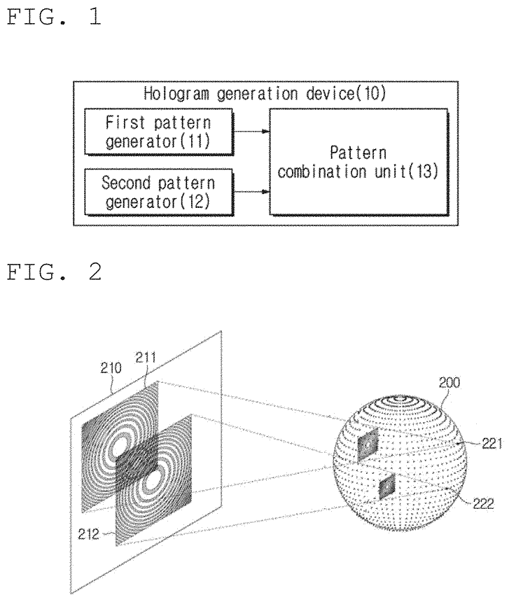

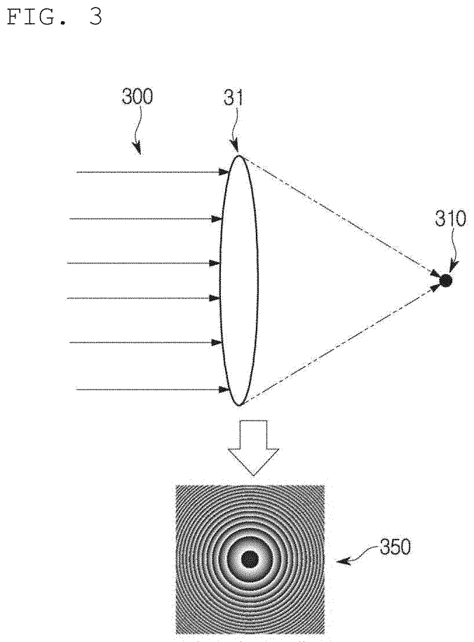

FIG. 1 is a block diagram showing a configuration of a hologram generation device according to an embodiment of the present disclosure.

Referring to FIG. 1, a hologram generation device 10 may include a first pattern generator 11, a second pattern generator 12, and a hologram pattern combination unit 13.

In order to generate a hologram image 200 in a space, hologram patterns 211 and 212 are generated on a hologram plane 210, and these hologram patterns 211 and 212 are constructed to correspond to respective points 221 and 222 that constitute an object included in the hologram image 200.

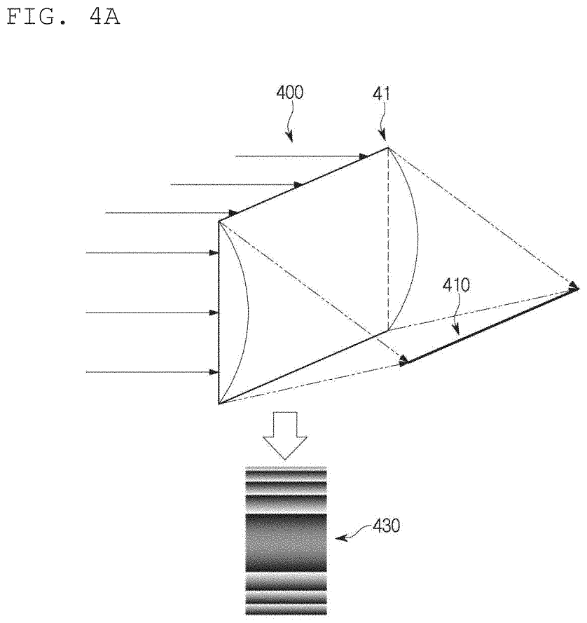

Herein, a general hologram pattern 350 (refer to FIG. 3) may be a pattern that is modeled on a shape of lens 31 capable of refracting incident light 300 to a target point 310. Herein, the lens 31 may be designed by considering a 2D position (e.g., x coordinate, y coordinate, etc.) of the target point 310.

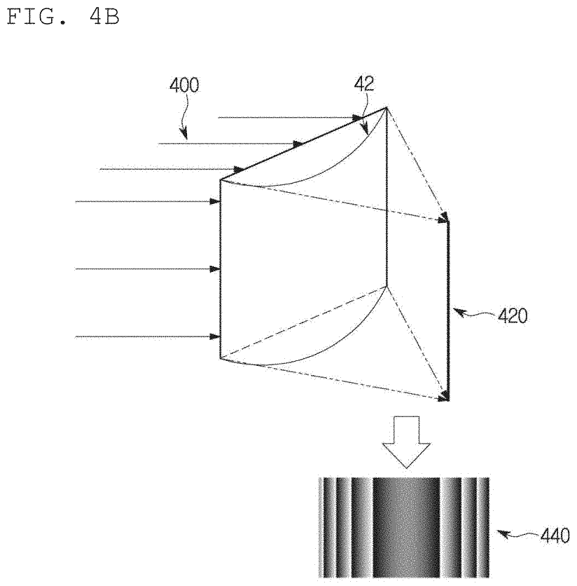

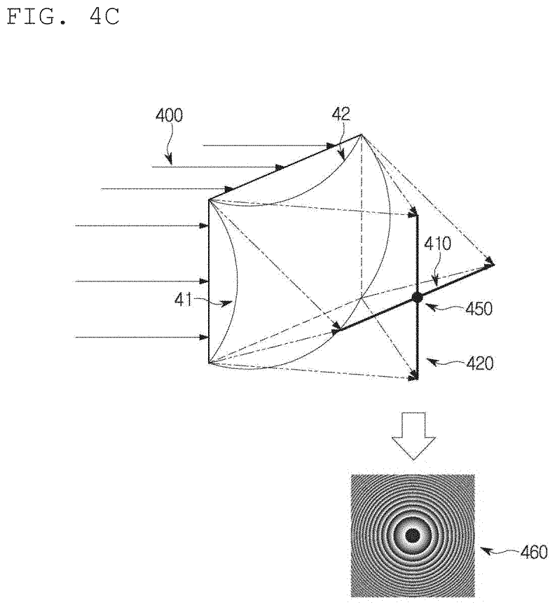

In consideration of the above description, the first pattern generator 11 may generate a first hologram pattern 430 that is constructed by modeling a first lens 41 capable of collecting incident light 400 (refer to FIG. 4A) on a first axis 410, and the second pattern generator 12 may generate a second hologram pattern 440 that is constructed by modeling a second lens 42 (refer to FIG. 4B) capable of collecting incident light 400 on a second axis 420. In addition, the hologram pattern combination unit 13 is configured to generate an intersection point between the first axis 410 based on the first lens 41 and the second axis 420 based on the second lens 42 as a target point 450.

For example, a first axis may be a horizontal axis, and a second axis may be a vertical axis. In consideration of Fresnel diffraction formula, when generating a hologram pattern, a target point 310 may be generated through the calculation of Equation 1 below. In consideration of this, the first pattern generator 11 may generate the first hologram pattern 410 through the calculation of Equation 2 below, and the second pattern generator 12 may generate the second hologram pattern 420 through the calculation of Equation 3 below. In addition, the hologram pattern combination unit 13 may output the final hologram pattern 460 through the calculation of Equation 4 below. Accordingly, the hologram generation device 10 may output the final hologram pattern 460 that may constitute the target point 430.

$$\begin{matrix}U ( x , y ) = \frac{{e}^{jkz}}{j λ z} \int {\int }_{- ∞}^{∞} U ( ζ , η ) exp \{ j \frac{k}{{2}_{Z}} [ {( x - ζ )}^{2} + {( y - η )}^{2} ] \} d ζ d η & [ Equation 1 ] \\ U ( x ) = \frac{{e}^{jkz}}{j {λ}_{Z}} {\int }_{- ∞}^{∞} U ( ζ ) exp \{ j \frac{k}{{2}_{Z}} {( x - ζ )}^{2} \} d ζ & [ Equation 2 ] \\ U ( y ) = \frac{{e}^{jkz}}{j {λ}_{Z}} {\int }_{- ∞}^{∞} U ( η ) exp \{ j \frac{k}{{2}_{Z}} {( y - η )}^{2} \} d η & [ Equation 3 ] \\ U ( x , y ) = U ( x ) U ( y ) & [ Equation 4 ]\end{matrix}$$

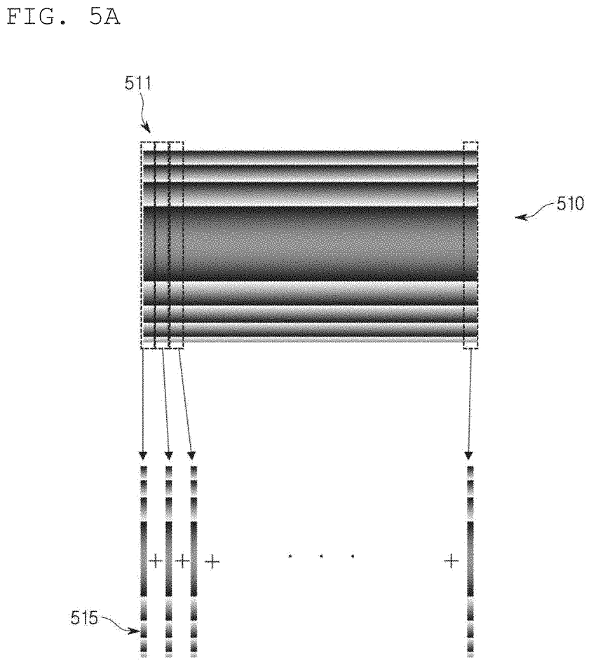

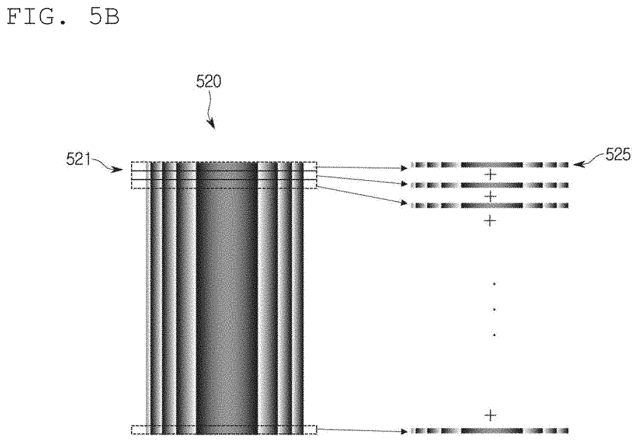

FIG. 5A and FIG. 5B are views illustrating structures of a first hologram pattern and a second hologram pattern that are generated by a hologram generation device according to an embodiment of the present disclosure.

Referring to FIG. 5A, a first hologram pattern 510 includes a first unit pattern 515 corresponding to a column unit 511 with a predetermined size and may be constructed by repeatedly combining the first unit pattern 515 in a plurality of columns. Inconsideration of this, when constructing a hologram pattern of each axial direction, the hologram generation device 10 may construct the first hologram pattern 510 by calculating only a matrix value of the first unit pattern 515 and repeatedly duplicating the value of the first unit pattern 515, which is already calculated, for a value of an orthogonal direction.

Likewise, referring to FIG. 5B, a second hologram pattern 520 includes a second unit pattern 525 corresponding to a row unit 521 with a predetermined size and may be constructed by repeatedly combining the second unit pattern 525 in a plurality of rows. Accordingly, when constructing a hologram pattern of each axial direction, the hologram generation device 10 may construct the second hologram pattern 520 by calculating only a matrix value of the second unit pattern 525 and repeatedly duplicating the value of the second unit pattern 525, which is already calculated, for a value of an orthogonal direction.

For example, the first and second pattern generators 11 and 12 may construct the first and second hologram patterns 510 and 520. As another example, the first and second pattern generators 11 and 12 may generate the first and second unit patterns 515 and 525 respectively, and the hologram pattern combination unit 13 may construct the first and second hologram patterns 510 and 520 by repeatedly duplicating the first and second unit patterns 515 and 525.

Thus, as the hologram generation device 10 constructs first and second hologram patterns using the first and second unit patterns 515 and 525, the amount of computation may be relatively reduced.

Also, as a hologram generation device according to an embodiment of the present disclosure constructs a hologram pattern by distinguishing a first hologram pattern and a second hologram pattern, in comparison with an existing method of calculating an optical path length for an overall hologram plane, the amount of calculation may be significantly reduced, and an optical field may be calculated at high speed.

In addition, as independent computation may be performed for a first hologram pattern and a second hologram pattern (e.g., axial direction), an asymmetrical optical model (e.g., a cylindrical lens, a prism, etc.) may be easily constructed.

Also, a storage medium or a storage space required to produce an ultra-high resolution optical field may be flexibly operated, and the resolution of a hologram may be increased due to a shortage of a storage medium or storage space.

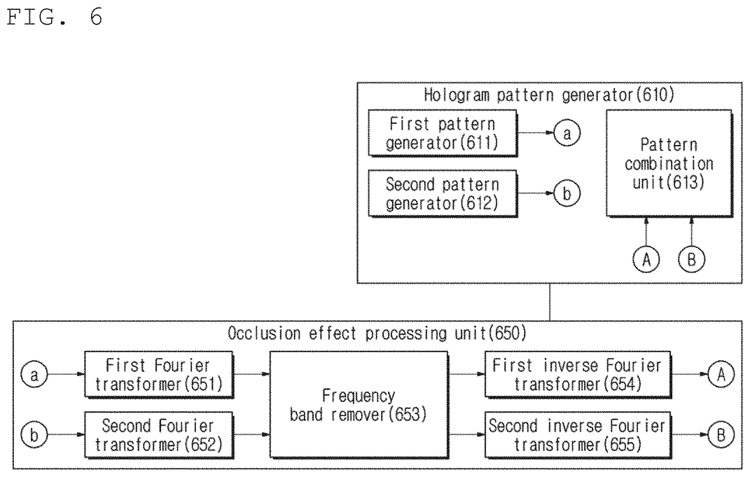

FIG. 6 is a block diagram showing a configuration of a hologram generation device according to another embodiment of the present disclosure.

Referring to FIG. 6, a hologram generation device 600 according to another embodiment of the present disclosure includes a hologram pattern generator 610 and an occlusion effect processing unit 650.

The hologram pattern generator 610 provided to the hologram generation device 600 according to another embodiment of the present disclosure may be configured basically in the same way as the first pattern generator 11, the second pattern generator 12 and the pattern combination unit 13 that are provided to the hologram generation device of FIG. 1. However, the hologram pattern generator 610 may be connected with the occlusion effect processing unit 650. In addition, the hologram pattern generator 610 may provide a first pattern a and a second pattern b, which are generated through axis separation, to the occlusion effect processing unit 650 and may construct a hologram image pattern by combining a first pattern A and a second pattern B that are provided by the occlusion effect processing unit 650. Herein, the first pattern a and the second pattern b, which the hologram pattern generator 610 provides to the occlusion effect processing unit 650, may be the above-described first and second hologram patterns. Meanwhile, the occlusion effect processing unit 650 may include first and second Fourier transformers 651 and 652, and the first and second Fourier transformers 651 and 652 may Fourier transform on the first hologram pattern a and the second hologram pattern b that are generated by separating an axis respectively. In addition, the occlusion effect processing unit 650 may include a frequency band remover 653, and the frequency band remover 653 may limit a predetermined frequency band, that is, a plane wave in a specific angle direction for an optical field of frequency band.

Specifically, when a specific carrier frequency of an optical field to be Fourier transformed is optically analyzed, a spatial position of a frequency band corresponds to a plane wave in a specific angle direction. When λ is a wavelength, fc is the frequency of a carrier wave, and θc is the direction of a specific angle corresponding to a carrier wave, they may be expressed by the relation of Equation 5 below.

$${f}_{c} = \frac{cos {θ}_{c}}{λ} \qquad [ Equation 5 ]$$

Accordingly, by spatially limiting an optical field that is calculated in a frequency band, it is possible to obtain an optical field in which information delivery of a carrier wave for a specific incidence angle direction is removed.

Thus, after the frequency band remover 653 spatially limits an optical field that is calculated in a specific frequency band, the occlusion effect processing unit 650 may perform inverse Fourier transform of corresponding patterns through first and second inverse Fourier transformers 654 and 655 respectively and may provide signals A and B of inverse-Fourier-transformed patterns to the hologram pattern generator 610.

Accordingly, a hologram pattern combination unit 613 of the hologram pattern generator 610 may ultimately construct a hologram image pattern by combining the signals A and B of inverse-Fourier-transformed patterns. Herein, the hologram pattern, which is ultimately constructed by the hologram pattern combination unit 613, may be an optical field in which information delivery for a carrier wave of a specific angle direction is removed.

When duplicating the optical field thus obtained for an orthogonal direction, calculating an optical field of another direction in the same process and then multiplying each element of the two optical fields, an optical field may be realized in which information delivery for each direction set for a single object point is limited, that is, which has an occlusion effect. Accordingly, when an occlusion angle for an object point is input, a hologram with a fast occlusion effect may be generated.

As another example, the first pattern a and the second pattern b, which the hologram pattern generator 610 provides to the occlusion effect processing unit 650, may be the above-described first and second unit patterns. In this case, first and second pattern generators 611 and 612 of the hologram pattern generator 610 may construct and provide first and second unit patterns respectively. In addition, the pattern combination unit 613 may construct first and second hologram patterns by repeatedly duplicating the first pattern A and the second pattern B, which are provided by the occlusion effect processing unit 650, in a row direction or in a column direction respectively, and may construct a final hologram pattern by using the first and second hologram patterns.

Thus, when the hologram pattern generator 610 provides the above-described first and second unit patterns as the first pattern a and the second pattern b, as operations like Fourier transform, inverse Fourier transform and frequency band removal are performed for a single row unit or a single column unit, the amount of computation of the occlusion effect processing unit 650 may be significantly reduced.

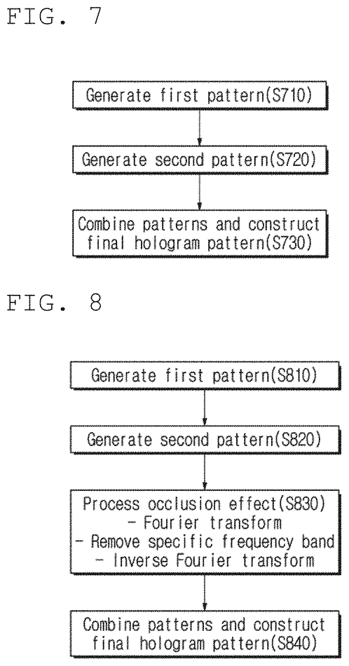

FIG. 7 is a flowchart illustrating an order in a method for generating a hologram according to an embodiment of the present disclosure.

A method for generating a hologram according to an embodiment of the present disclosure may be implemented by the above-described hologram generation device.

First, in the step S710, a hologram generation device may generate the first hologram pattern 430 that is constructed by modeling the first lens 41 capable of collecting the incident light 400 (refer to FIG. 4A) on the first axis 410.

Also, in the step S720, the hologram generation device may generate the second hologram pattern 440 that is constructed by modeling the second lens 42 (refer to FIG. 4B) capable of collecting the incident light 400 on the second axis 420.

In the step S730, the hologram generation device is configured to generate an intersection point between the first axis 410 based on the first lens 41 and the second axis 420 based on the second lens 42 as a target point 450 by combining the first pattern and the second pattern.

For example, the hologram generation device may generate the first pattern through the above-described calculation of Equation 2 and generate the second pattern through the above-described calculation of Equation 3. In addition, the hologram generation device may construct a final hologram pattern through the above-described calculation of Equation 4. Accordingly, the hologram generation device may output the final hologram pattern that may constitute the target point 430.

In the above-described hologram generation device according to an embodiment of the present disclosure, first and second patterns may be constructed as a first hologram pattern and a second hologram pattern respectively.

Accordingly, in the steps S710 and S720, the hologram generation device may construct the first and second patterns as the first hologram pattern and the second hologram pattern respectively and, in the step S730, may construct a final hologram pattern through multiplication operation of the first hologram pattern and the second hologram pattern.

As another example, the first and second patterns may be constructed as a first unit pattern and a second unit pattern respectively. For example, the first hologram pattern 510 (refer to FIG. 5A) includes the first unit pattern 515 corresponding to the column unit 511 with a predetermined size and may be constructed by repeatedly combining the first unit pattern 515 in a plurality of columns. Likewise, the second hologram pattern 520 (refer to FIG. 5B) includes the second unit pattern 525 corresponding to the row unit 521 with a predetermined size and may be constructed by repeatedly combining the second unit pattern 525 in a plurality of rows. In consideration of this, in the steps S710 and S720, when constructing a hologram pattern of each axial direction, the hologram generation device may calculate only a matrix value for the first unit pattern 515 and a matrix value for the second unit pattern 525. In addition, in the step S730, the hologram generation device may construct the first hologram pattern 510 by repeatedly duplicating the value of the first unit pattern 515, which is already calculated, and construct the second hologram pattern 520 by repeatedly duplicating the value of the second unit pattern 525. In addition, in the step S730, the hologram generation device may construct a final hologram pattern by combining the first hologram pattern 510 and the second hologram pattern 520.

Thus, as the hologram generation device processes the first and second unit patterns 515 and 525 and reconstructs first and second hologram patterns in a process of constructing a final hologram pattern, the amount of computation may be relatively reduced.

Also, as a hologram generation device according to an embodiment of the present disclosure constructs a hologram pattern by distinguishing a first hologram pattern and a second hologram pattern, in comparison with an existing method of calculating an optical path length for an overall hologram plane, the amount of calculation may be significantly reduced, and an optical field may be calculated at high speed. In addition, as independent computation may be performed for a first hologram pattern and a second hologram pattern (e.g., axial direction), an asymmetrical optical model (e.g., a cylindrical lens, a prism, etc.) may be easily constructed.

Also, a storage medium or a storage space required to produce an ultra-high resolution optical field may be flexibly operated, and the resolution of a hologram may be increased due to a shortage of a storage medium or storage space.

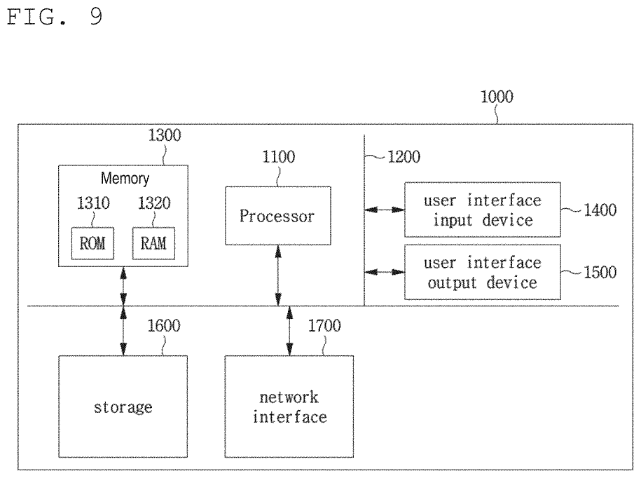

FIG. 8 is a flowchart illustrating an order in a method for generating a hologram according to another embodiment of the present disclosure.

In a method of generating a hologram according to another embodiment of the present disclosure, a step of generating a first pattern and a step of generating a second pattern (S810 and S820) may be constructed to the be the same as the generating steps (S710 and S720) in a method of generating a hologram according to an embodiment of the present disclosure. However, the method of generating a hologram according to another embodiment of the present disclosure may further include a step of processing an occlusion effect (S830).

Specifically, a first pattern a and a second pattern b, which are generated through the steps S810 and S820, may be used to process an occlusion effect. That is, in the step S830, a hologram generation device may perform Fourier transform processing for the first pattern a and the second pattern b respectively.

Next, the hologram generation device may limit a predetermined frequency band, that is, a plane wave of a specific angle direction for an optical field of a frequency band. Specifically, when a specific carrier frequency of an optical field to be Fourier transformed is optically analyzed, a spatial position of a frequency band corresponds to a plane wave in a specific angle direction. When λ is a wavelength, fc is the frequency of a carrier wave, and θc is the direction of a specific angle corresponding to a carrier wave, they may be expressed by the relation of Equation 5 described above.

By spatially limiting an optical field that is calculated in a frequency band, the hologram generation device may obtain an optical field in which information delivery of a carrier wave for a specific incidence angle direction is removed.

Thus, after spatially limiting an optical field that is calculated in a specific frequency band, the hologram generation device may perform inverse Fourier transform for each corresponding pattern and may provide signals A and B of inverse-Fourier-transformed patterns.

Next, in the step S840, the hologram pattern generator 610 may ultimately construct a hologram image pattern by combining the signals A and B of inverse-Fourier-transformed patterns. Herein, the hologram pattern that is ultimately constructed may be an optical field in which information delivery for a carrier wave of a specific angle direction is removed.

When duplicating the optical field thus obtained for an orthogonal direction, calculating an optical field of another direction in the same process and then multiplying each element of the two optical fields, an optical field may be realized in which information delivery for each direction set for a single object point is limited, that is, which has an occlusion effect. Accordingly, when an occlusion angle for an object point is input, a hologram with a fast occlusion effect may be generated.

Meanwhile, the first pattern a and the second pattern b that are processed in the step S830 may be the above-described first and second unit patterns. Accordingly, in the step S830, the hologram generation device may perform Fourier transform for the first and second unit patterns and may perform an operation of removing a specific frequency band for a signal thus transformed. In addition, the hologram generation device may construct a first pattern A and a second pattern B by performing inverse Fourier transform for the first and second unit patterns with the specific frequency band being removed.

Next, in the step S840, the hologram generation device may construct first and second hologram patterns by repeatedly duplicating the first pattern A and the second pattern B in a row direction or in a column direction respectively and may construct a final hologram pattern by using the first and second hologram patterns.

Thus, when the hologram generation device provides the above-described first and second unit patterns as the first pattern a and the second pattern b, as operations like Fourier transform, inverse Fourier transform and frequency band removal are performed for a single row unit or a single column unit, an amount of computation required to process an occlusion effect may be significantly reduced.

FIG. 9 is a block diagram illustrating a computing system implementing an apparatus and method for generating a hologram according to an embodiment of the present disclosure.

Referring to FIG. 9, a computing system. 100 may include at least one processor 1100 connected through a bus 1200, a memory 1300, a user interface input device 1400, a user interface output device 1500, a storage 1600, and a network interface 1700.

The processor 1100 may be a central processing unit or a semiconductor device that processes commands stored in the memory 1300 and/or the storage 1600. The memory 1300 and the storage 1600 may include various volatile or nonvolatile storing media. For example, the memory 1300 may include a ROM (Read Only Memory) and a RAM (Random Access Memory).

Accordingly, the steps of the method or algorithm described in relation to the embodiments of the present disclosure may be directly implemented by a hardware module and a software module, which are operated by the processor 1100, or a combination of the modules. The software module may reside in a storing medium (that is, the memory 1300 and/or the storage 1600) such as a RAM memory, a flash memory, a ROM memory, an EPROM memory, an EEPROM memory, a register, a hard disk, a detachable disk, and a CD-ROM. The exemplary storing media are coupled to the processor 1100 and the processor 1100 can read out information from the storing media and write information on the storing media. Alternatively, the storing media may be integrated with the processor 1100. The processor and storing media may reside in an application specific integrated circuit (ASIC). The ASIC may reside in a user terminal. Alternatively, the processor and storing media may reside as individual components in a user terminal.

The exemplary methods described herein were expressed by a series of operations for clear description, but it does not limit the order of performing the steps, and if necessary, the steps may be performed simultaneously or in different orders. In order to achieve the method of the present disclosure, other steps may be added to the exemplary steps, or the other steps except for some steps may be included, or additional other steps except for some steps may be included.

Various embodiments described herein are provided to not arrange all available combinations, but explain a representative aspect of the present disclosure and the configurations about the embodiments may be applied individually or in combinations of at least two of them.

Further, various embodiments of the present disclosure may be implemented by hardware, firmware, software, or combinations thereof. When hardware is used, the hardware may be implemented by at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), a general processor, a controller, a micro controller, and a micro-processor.

The scope of the present disclosure includes software and device-executable commands (for example, an operating system, applications, firmware, programs) that make the method of the various embodiments of the present disclosure executable on a machine or a computer, and non-transitory computer-readable media that keeps the software or commands and can be executed on a device or a computer.

What is claimed is:

1. An apparatus for generating a hologram, the apparatus comprising:
a first pattern generator configured to generate a first hologram pattern that is constructed by modeling a first lens capable of collecting incident light on a first axis;
a second pattern generator configured to generate a second hologram pattern that is constructed by modeling a second lens capable of collecting the incident light on a second axis; and
a hologram pattern combination unit configured to construct a final hologram pattern by combining the first and second patterns.

2. The apparatus of claim 1, wherein the first axis and the second axis are made based on a horizontal axis (x-axis) and a vertical axis (y-axis).

3. The apparatus of claim 1, wherein the first axis and the second axis are perpendicular to each other.

4. The apparatus of claim 1, wherein the hologram pattern combination unit is further configured to process a multiplication operation for the first and second patterns.

5. The apparatus of claim 1, wherein the first pattern generator generates a first unit pattern corresponding to a column unit that is a basis of the first hologram pattern comprising a plurality of columns, and
wherein the second pattern generator generates a second unit pattern corresponding to a row unit that is a basis of the second hologram pattern comprising a plurality of rows.

6. The apparatus of claim 5, wherein the hologram pattern combination unit is configured to:
generate the first hologram pattern comprising the plurality of columns by duplicating the first unit pattern,
generate the second hologram pattern comprising the plurality of rows by duplicating the second unit pattern, and
process a multiplication operation for the first and second hologram patterns.

7. The apparatus of claim 1, wherein the first pattern generator is further configured to process calculation of Equation 1 below.
$$U ( x ) = \frac{{e}^{jkz}}{j {λ}_{Z}} {\int }_{- ∞}^{∞} U ( ζ ) exp \{ j \frac{k}{{2}_{Z}} {( x - ζ )}^{2} \} d ζ . \qquad [ Equation 1 ]$$

8. The apparatus of claim 7, wherein the second pattern generator is further configured to process calculation of Equation 2 below.
$$U ( y ) = \frac{{e}^{jkz}}{j {λ}_{Z}} {\int }_{- ∞}^{∞} U ( η ) exp \{ j \frac{k}{{2}_{Z}} {( y - η )}^{2} \} d η . \qquad [ Equation 2 ]$$

9. The apparatus of claim 1, further comprising:
an occlusion effect processing unit configured to:
identify an optical field of a frequency band for the first and second hologram patterns respectively, and
remove an optical field at a predetermined incidence angle based on the optical field of the frequency band.

10. The apparatus of claim 9, wherein the occlusion effect processing unit comprises:
a first Fourier transform processing unit configured to execute Fourier transform for the first hologram pattern;
a second Fourier transform processing unit configured to execute Fourier transform for the second hologram pattern;
a frequency band remover configured to remove at least one of frequency bands of the first and second hologram patterns that are provided by the first Fourier transform processing unit and the second Fourier transform processing unit;
a first inverse transform processing unit configured to process inverse Fourier transform for a frequency band of the first hologram pattern provided by the frequency band remover; and
a second inverse transform processing unit configured to process inverse Fourier transform for a frequency band of the second hologram pattern provided by the frequency band remover.

11. The apparatus of claim 10, wherein the hologram pattern combination unit is further configured to generate the final hologram pattern by combining the first hologram pattern and the second hologram pattern that are output from the first inverse transform processing unit and the second inverse transform processing unit.

12. The apparatus of claim 5, further comprising:
an occlusion effect processing unit configured to:
identify an optical field of a frequency band for the first unit pattern and the second unit pattern respectively, and
remove an optical field at a predetermined incidence angle based on the optical field of the frequency band.

13. The apparatus of claim 12, wherein the occlusion effect processing unit comprises:
a first Fourier transform processing unit configured to execute Fourier transform for the first unit pattern;
a second Fourier transform processing unit configured to execute Fourier transform for the second unit pattern;
a frequency band remover configured to remove at least one frequency band among frequency bands of the first and second unit patterns that are provided by the first Fourier transform processing unit and the second Fourier transform processing unit;
a first inverse transform processing unit configured to process inverse Fourier transform for a frequency band of the first unit pattern provided by the frequency band remover; and
a second inverse transform processing unit configured to process inverse Fourier transform for a frequency band of the second unit pattern provided by the frequency band remover.

14. The apparatus of claim 13, wherein the hologram pattern combination unit is further configured to:
construct the first and second hologram patterns by duplicating the first and second unit patterns that are output from the first inverse transform processing unit and the second inverse transform processing unit, and
generate the final hologram pattern by combining the first and second hologram patterns.

15. A method for generating a hologram, the method comprising:
generating a first hologram pattern that is constructed by modeling a first lens capable of collecting incident light on a first axis;
generating a second hologram pattern that is constructed by modeling a second lens capable of collecting the incident light on a second axis; and
constructing a final hologram pattern by combining the first and second hologram patterns.

16. The method of claim 15, further comprising:
identifying an optical field of a frequency band for the first and second hologram patterns respectively; and
removing an optical field at a predetermined incidence angle based on the optical field of the frequency band.

17. The method of claim 15, wherein the generating of the first hologram pattern comprises generating a first unit pattern corresponding to a column unit that is a basis of the first hologram pattern comprising a plurality of columns, and
wherein the generating of the second hologram pattern comprises generating a second unit pattern corresponding to a row unit that is a basis of the second hologram pattern comprising a plurality of rows.

18. The method of claim 17, wherein the constructing of the final hologram pattern comprises:
generating the first hologram pattern comprising the plurality of columns by duplicating the first unit pattern;
generating the second hologram pattern comprising the plurality of rows by duplicating the second unit pattern; and
constructing the final hologram pattern by processing a multiplication operation for the first and second hologram patterns.

19. The method of claim 18, further comprising:
identifying an optical field of a frequency band for the first and second unit patterns respectively; and
removing an optical field at a predetermined incidence angle based on the optical field of the frequency band.

20. The method of claim 19, wherein the removing of the optical field comprises:
executing Fourier transform for the first unit pattern;
executing Fourier transform for the second unit pattern;
removing at least one frequency band among frequency bands of the first unit pattern and the second unit pattern that are first and second Fourier transformed;
processing inverse Fourier transform for the first unit pattern in which the at least one frequency band is removed; and
processing inverse Fourier transform for the second unit pattern in which the at least one frequency band is removed.
